(19) United States
(12) Patent Application Publication
(10) Pub. No.: US 2016/0141906 A1
(43) Pub. Date: May 19, 2016

(54) CHARGING AND DISCHARGING CONTROL CIRCUIT FOR BATTERY DEVICE

(71) Applicant: Duck Young JUNG, Yongin-shi, Gyeonggi-do (KR)

(72) Inventor: Duck Young JUNG, Yongin-si (KR)

(21) Appl. No.: 14/898,124

(22) PCT Filed: May 19, 2014
(86) PCT No.: PCT/KR2014/004438

§ 371 Date: Dec. 12, 2015

(30) Foreign Application Priority Data
Jun. 13, 2013 (KR) 10-2013-0067579

(51) Int. Cl. H02J 7/00

(52) U.S. Cl. CPC H02J 7/0072

(57) ABSTRACT

A source of a pass-on FET is connected to a charger (load) terminal node connected to a battery terminal, a drain of the pass-on FET is connected to a gate of the current-pass FET, a gate of the pass-on FET is connected to a first control signal of a controller, a drain of the current-pass FET is connected to the other terminal of a battery, and a source of the current-pass FET is connected to one terminal of a charger. Two pass-off FETs are connected in series between the drain and the gate of the current-pass FET, one of gates of the two pass-off FETs is connected to a second control signal outputted from the controller, the other one of the gates of the two pass-off FETs is connected to a level converter, and an input of the level converter is connected to the second control signal.

### TECHNICAL FIELD

The present invention relates to a charging and discharging control circuit for a battery device, and in particular to a battery protection circuit which is able to control charging and discharging without any leakage current when controlling the charging and discharging of a secondary battery by using one current pass control FET (Field Effect Transistor).

### BACKGROUND ART

FIG. 29 shows a conventional battery protection circuit which is most generally used. Two current pass MOS-FET are used when controlling the charge and discharge currents of a battery.

FIG. 30 shows an equivalent circuit wherein current pass MOS-FET 313 and 314 are on in order for the charging and discharging to be simultaneously available when the conventional circuit in FIG. 29 normally operates. In the normal state, two current pass MOS-FET are communicative in both directions. The current pass MOS-FET 313 is turned on and the MOS-FET 314 is turned off so that the conventional circuit in FIG. 29 can become a charge-prohibited state and a discharge-possible state after it detects an abnormal state, whereupon the current in the charging direction cannot flow. A parasitic diode of the FET 314 will allow the current to flow in the discharging direction. FIG. 31 shows an equivalent circuit which will carry out the above operations. Since the current pass MOS-FET 314 is turned on and the MOS-FET 313 is turned off so that the conventional circuit in FIG. 29 can become a discharge-prohibited state and a charge-possible state after it detects an abnormal state, the current in the discharging direction cannot flow; however the parasitic diode of the FET 313 allows the current to flow in the charging circuit. FIG. 32 shows an equivalent circuit.

In the conventional technology as in FIG. 29, the current pass control unit 307 uses two MOS-FET and in general is configured in an external type which is separate from the control circuit. If the MOS-FET is built in one silicon chip, a relatively huge area is required, which may result in a greatly increased cost. If it is formed of one chip, the required area for the current pass MOS-FET may be reduced to ¼. To this end, a structure which uses only one current pass control MOS-FET is necessary.

The Japanese paten publication number 2000-102182 (FIG. 33) describes a conventional technology wherein a charging and discharging can be controlled using one MOS-FET.

According to the operations in FIG. 33, when the system normally operates, the FET 301 is turned on, the FET 304 and 305 are turned off, and the FET 306 is turned on, so the charging and discharging can be simultaneously carried out. In the operation in FIG. 33, the control for the sake of a charge-prohibited state and a discharge-possible state may be that the FET 301 is turned off, the FET 304 is turned off, and when the FET 305 is turned on, the gate voltage at the FET 306 may be “0” with respect to the V-terminal 121. In addition, the control for the sake of a discharge-prohibited state and a charge-possible state may be that the FET 301 is turned off, the FET 304 is turned on, and the FET 305 is turned off. In this state, the discharging is prohibited, but the charge is possible. In the above described operation, no problem may exist in terms of a logic operation, but the gate voltage at the current pass FET 306 in a charge or discharge-prohibited state may always have a predetermined uncertain value below the normal direction voltages at the short key diode 302 and 303, and there may exist a possibility wherein the FET 306 may allow the leakage current to flow in both directions. The short key diode process is required, and since a special process is added, manufacturing cost will inevitably increase.

FIG. 34 shows that one current pass control FET is used without the above short key diode. The circuit which can be manufactured with a standard CMOS is disclosed in the Korean patent application number 10-2011-0088835.

As illustrated in FIG. 34, in the normal state operation, the FET 110 is turned on, and the FET 111 is turned off, and the FET 114 becomes a full on state, so the charge and discharge are possible. The control of the charge-prohibited state and the charge-possible state may be that the FET 110 is turned off, the FET 111 is turned on, and the gate voltage at the FET 114 is same as the V-terminal 121, so the charging direction is a reverse direction, and the discharging direction is a normal direction. The design in FIG. 34 may be an incomplete design since the controls of the discharge-prohibited state and the charge-possible state are not defined.

FIG. 35 shows a technology which improves the problems in FIG. 34 and is disclosed in the Koran patent application number 10-2011-0088548.

The operation in FIG. 35 is as follows. The control wherein the charge and discharge in the normal state are available is that the FET 110 is turned on, the FET 111 is turned off, and the FET 161 and 162 are turned off. At this time, as the gate of the FET 114 is high, it may be in the full on state, so the charge and discharge are available. The control circuits detects a charge-prohibited state, and the control in the charge-prohibited state and the discharge-possible state may be that the FET 110 is turned off, the FET 111 is turned on, and the FET 161 is turned off, and the FET 162 is turned on, and the gate voltage at the current pass control FET 114 may be the same as the V-terminal 121. In this state, the charge current direction is in a reverse direction, and the discharge current direction is a normal direction, so the charge-prohibited state and the discharge-possible state can be implemented. The control circuit detects a discharge-prohibited state, and the control in the discharge-prohibited state and the charge-possible state may be that the FET 110 is turned off, the FET 111 is turned on, and the FET 161 is turned on, and the FET 162 is turned off. The gate voltage at the current pass control FET 114 may be the same as a negative terminal 123. In this state, the discharge current direction may be a reverse direction, and the charge current direction may be a normal direction, so the discharge-prohibited state and the charge-possible state can be implemented. The logic configuration on the abnormal state operation is possible, but in the charge-prohibited state, leakage current may occur in the FET 161 and 162, which hereinafter will be described.

FIG. 35 shows a control of the charge-prohibited state (discharge-possible state). In this state, the voltage at the V-terminal 121 is lower than the voltage at the negative terminal 123 of the battery by a charger. At this time, the gate voltage at the FET 114 is the same as the V-terminal 121, and the gate voltage at the FET 161 is the same as the negative terminal 123 of the battery, and the common terminals of the FET 161 and the FET 162 are the same as the V-terminal 121, the voltage at the node 128 of the FET 16 is higher than the voltage at the node 125, so the normal direction may be formed from the node 123 to the common nodes of the FET 161 and the FET 162, so current pass occurs. To this end, the leakage current in the direction of the V-terminal 121 may occur at the negative terminal 123 of the battery while flowing via the FET 162 from the FET 161, wherein charging continuously occurs.

In the charge and discharge control circuit which uses one current pass control FET, the use of a special device, for example, a short key diode, may not cause a serious problem, but the generated leakage current as a huge problem may cause problems in terms of the service life of the battery and degradation, so it needs to invent a new circuit which does not cause any leakage current.

### SUMMARY OF THE INVENTION

Disclosure of the Invention

Accordingly, it is an object of the present invention to provide a stable battery charge and discharge circuit which is able to basically prevent the problems which are encountered in the conventional charge and discharge control technology (FIG. 35) wherein the leakage current occurring at the FET 161 and 162 provided to control the gate voltage of the current pass control FET 114 occurs due to a voltage difference between the V-terminal 121 and the negative terminal 123 of the battery.

### Technical Solution

To achieve the above objects, there is provided a circuit configuration which is able to control charge and discharge.

In the above circuit configuration, the source of a pass-on FET (first FET) is connected to a first terminal node of a charger (load) directly connected to a first terminal of a battery, and the drain of the pass-on FET (first FET) is connected to the gate of a current pass FET (sixth FET), and the gate of the pass-on FET (first FET) is connected to a first control signal of the controller, and the drain of the current pass FET (sixth FET) is connected to a second terminal of the battery, and the source of the current pass FET (sixth FET) is connected to a second terminal of the charger.

Two pass-off FET (third and fourth FET) are connected in series between the drain and gate of the current pass FET (sixth FET), and any of the gates of the two pass-off FET (third and fourth FET) is connected to a second control signal from the controller, and the other one between the gates of the two pass-off FET (third and fourth FET is connected to a level converter, and the input of the level converter is connected to the second control signal. Two pass-off FET (fifth and sixth FET) are connected in series between the source and gate of the current pass FET(sixth FET), and the gates of the two other pass-off FET (fifth and sixth FET) are connected with a third control signal from the controller.

### Advantageous Effects

The present invention is directed to a charge and discharge control circuit which uses one current pass FET wherein the service life of the battery can be extended and the degradation can be prevented in such a way to provide a “0 (zero)” level of the leakage current, not a reduced level.

### BRIEF DESCRIPTION OF DRAWINGS

FIG. 1 is a view illustrating a battery charge and discharge control circuit according to a first exemplary embodiment of the present invention.

FIG. 1—100: First terminal of battery FIG. 1—101: Second terminal of battery

FIG. 1—102: First terminal of charger (load) FIG. 1—103: Second terminal of charger (load)

FIG. 1—124: First control signal FIG. 1—121: Second control signal FIG. 1—122: Third control signal

FIG. 1—105: First FET (pass-on FET) FIG. 1—110: Sixth FET (current pass FET)

FIG. 1—106, 107: Second and third FET (pass-off FET)

FIG. 1—108, 109: Fourth and fifth FET (pass-off FET)

FIGS. 2 to 7 are views illustrating an equivalent circuit in each state of a first exemplary embodiment of the present invention.

FIG. 8 is a view illustrating a battery charge and discharge control circuit according to a second exemplary embodiment of the present invention.

FIGS. 9 to 14 are views illustrating an equivalent circuit with respect to each state according to a second exemplary embodiment of the present invention.

FIG. 15 is a view illustrating a battery charge and discharge control circuit according to a third exemplary embodiment of the present invention.

FIGS. 16 to 21 are views illustrating an equivalent circuit in each state according to a third exemplary embodiment of the present invention.

FIG. 22 is a view illustrating a battery charge and discharge control circuit according to a fourth exemplary embodiment of the present invention.

FIGS. 23 to 28 are views illustrating an equivalent circuit in each state according to a fourth exemplary embodiment of the present invention.

FIG. 29 is a view illustrating a conventional charge and discharge control circuit which uses two current pass FET.

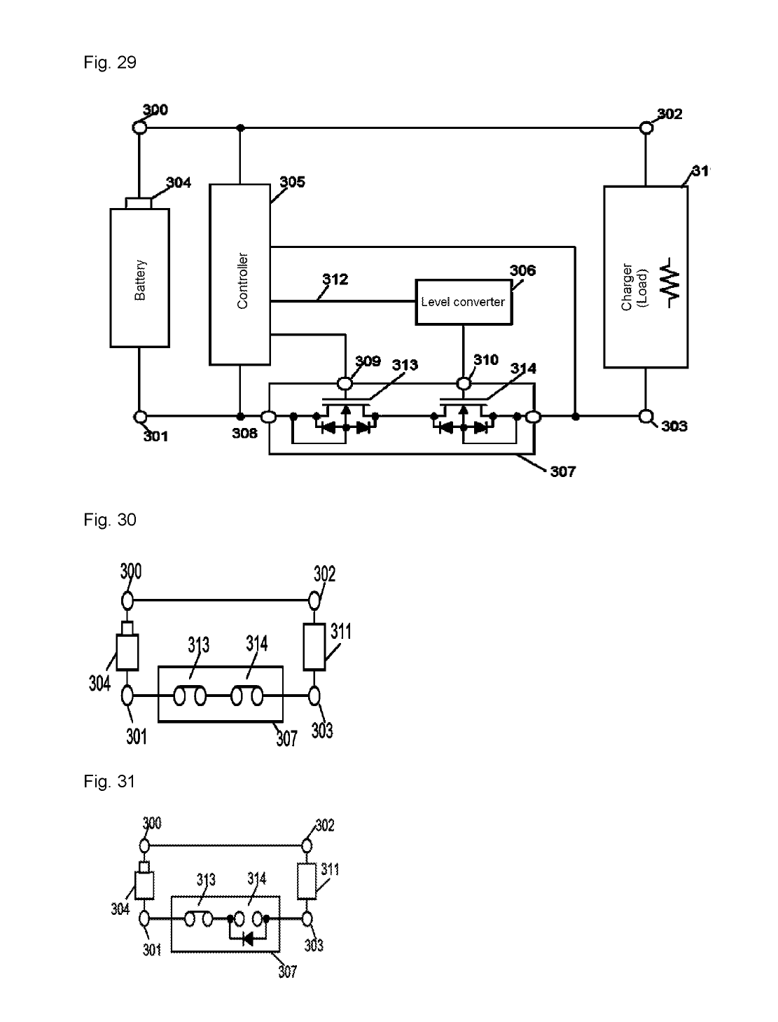

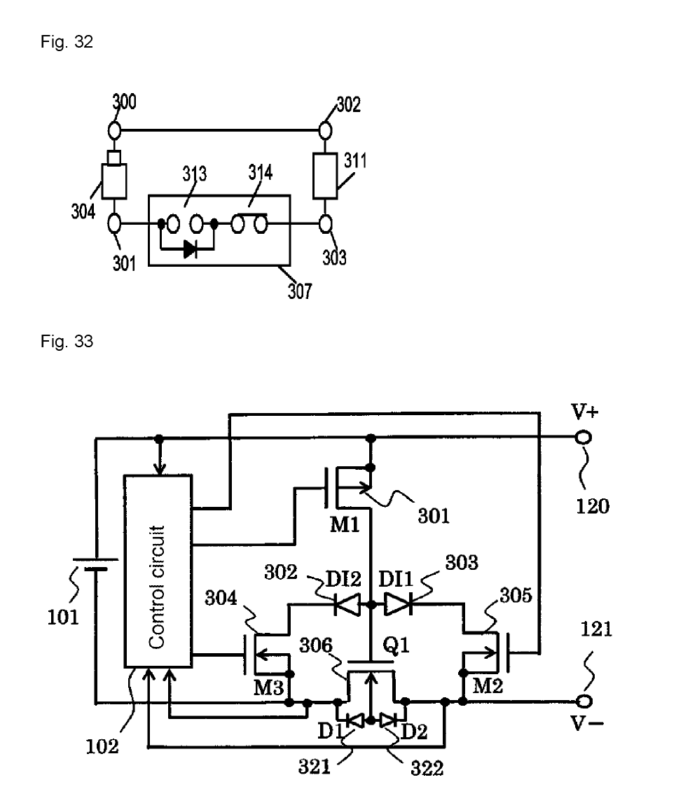

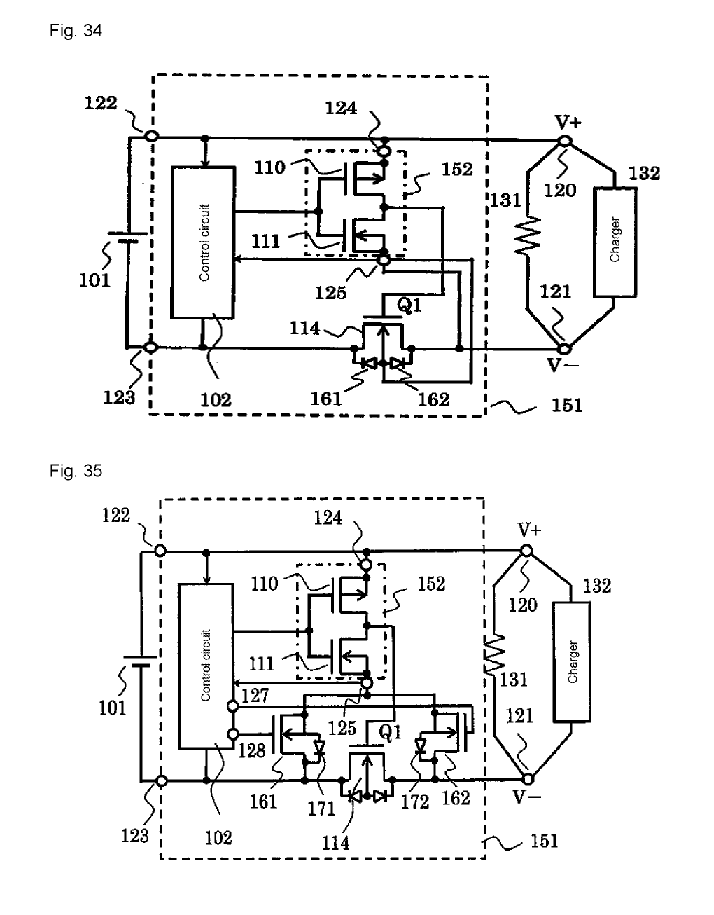

FIGS. 20 to 32 are views illustrating an equivalent circuit in each state.

FIG. 33 is a view illustrating a conventional technology (Japanese publication number 2000-102182).

FIG. 34 is a view illustrating a conventional technology (Korean patent application number 10-2011-0088835)

FIG. 35 is a view illustrating a conventional technology (Korean patent application number 10-2011-0088548)

### BEST MODES FOR CARRYING OUT THE INVENTION

As for the reference numbers in the drawings assigned to describe the embodiments, the same function are given the same reference numbers for convenience.

### First Exemplary Embodiment

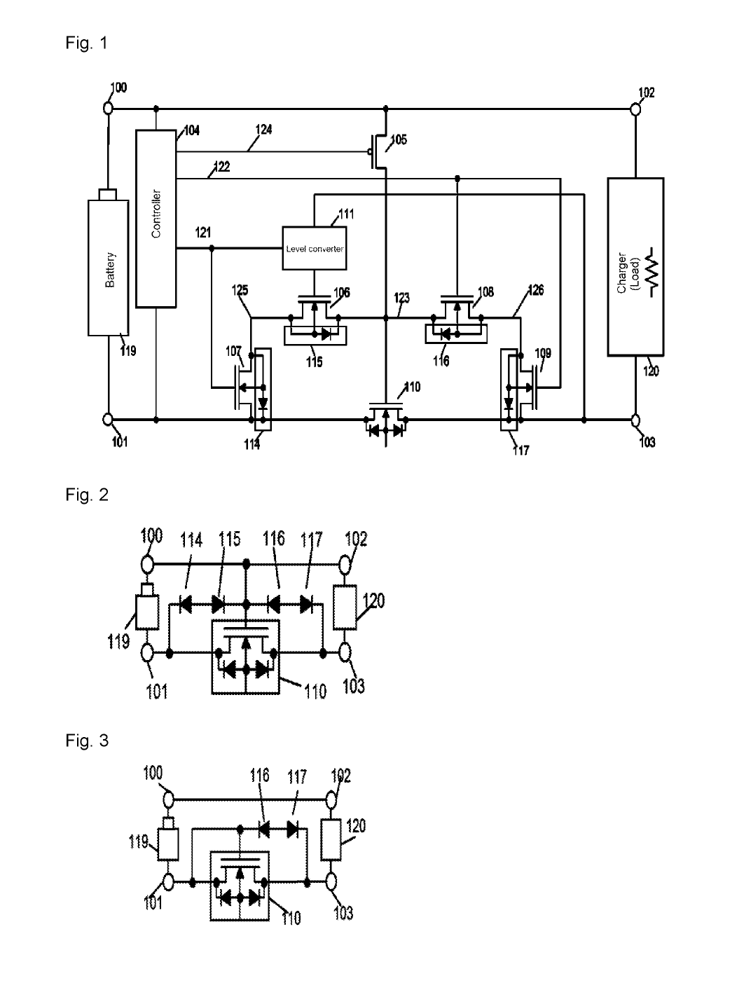

FIG. 1 is a view illustrating a battery charge and discharge control circuit which includes a controller 104 according to a first exemplary embodiment of the present invention.

The charge and discharge control circuit according to a first exemplary embodiment of the present invention may include, but is not limited to, a controller 104; a current pass FET 110; a level converter 111; a pass-on FET 105; and pass-off FET (106, 107, 108 and 109).

The source of the pass-on FET 105 is connected to the common terminals 100 and 102 of the battery 119 and the charger (load) 120, and the gate of the FET 105 is connected to a first control signal 124. The first control signal is a signal which in general represents a normal state. The drain of the FET 105 is connected to the gate of the current pass FET 110. One terminal of the battery 119 is connected to the drain (source) of the current pass FET 110, and the other source (drain) of the current pass FET 110 is connected to a terminal 103 of the charger (load) 120. The pass-off FET 107 which receives a second control signal 121 as a gate input and the source of the FET 107 are connected to the node of the battery terminal 101, and the drain of the FET 107 is connected to the drain of the pass-off FET 106, and the gate of the FET 106 is connected to the level converter 111, and the level converter 111 is connected to the second control signal 121. The source of the FET 106 is connected to the gate node 123 of the FET 110. The pass-off FET 109 which receives a third control signal as a gate input and the source of the FET 109 are connected to the node of the charger (load) terminal 103, and the drain of the FET 109 is connected to the drain of pass-off FET 108, the gate of PET 108 is connected to the third control signal 122. The source of the FET 108 is connected to the gate node 123 of the FET 110. The second and third signals indicate that a common battery is in an abnormal state. The other control signals will be seen in the drawings.

The operations according to the first exemplary embodiment of the present invention will be described.

The charge and discharge control circuit may have the following three modes: a normal operation state, a discharge-prohibited state (charge is available), and a charge-prohibited state (discharge is available). In the above three modes, the controller 104 checks and detects the states of the battery node 101 and the charger node 103. The following descriptions are on the circuit which is provided to control the current pass FET 110 after the controller 104 has detected the states.

In FIG. 1, the normal state operations are as follows.

The current pass FET 110 should be turned on. For this, when the pass-on FET 105 is turned on, and the pass-off FET 106, 107, 108 and 109 are turned off, the current pass FET 10 turns into the full on state, thus passing the current in both directions. The electric equivalent circuit in the above state is shown in FIGS. 2 and 5. The pass-on FET 105 are connected multiple in number in series and may be configured to receive multiple control signals. At the positions of the bulk nodes of the pass-off FET 106 and 107, each parasitic diode is formed in a reverse direction, so the leakage current does not occur. The bulk positions of the pass-off FET 106 and 107 and FET 108 and 109 are two kinds like the equivalent circuit in FIGS. 2 and 5. In the normal state, the current pass FET 110 is in the full on state, and there rarely is a difference between the electric potential at the battery node 101 and the electric potential at the charger node 103. So, as long as only the positions of the parasitic diodes of the pass-off FET 106, 107, 108 and 109 are determined as mentioned above, a leakage current will not occur.

The operation of the discharge-prohibited (charge is available) in FIG. 1 will be described below.

The controller 104 turns off the pass-on FET 105 and the pass-off FET 108 and 109 and turns on the pass-off FET 106 and 107. The equivalent circuit in the above case is shown in FIGS. 3 and 6. The charging direction becomes a normal direction where the current pass FET 110 is in the MOS-diode type, so the charging becomes available, and the discharging is prohibited since the discharge direction becomes a reverse direction.

As a way to resolve the leakage current occurrence problem due to the conventional pass-off FET (FIGS. 35-162 and 161) in the conventional technology, a pair of pass-off FET 108 and 109 connected in series are provided between the gate node 123 of the current pass FET 110 and the load node 103. The gate node 122 of the FET 109 is a low state, and its electric potential is the same as at the node 101 and is the same as the electric potential at the gate node 123 of the current pass FET 110. In the discharge-prohibited state, the load 120 is connected, and the electric potential at the node 103 is possible to rise to the electric potential at the maximum node 100. In this state, since the gate of the FET 109 may be a 0V stage, the leakage current will be prevented irrespective of the state of the pass-off FET 108.

The operation of the charge-prohibited (discharge is available) in FIG. 1 will be described.

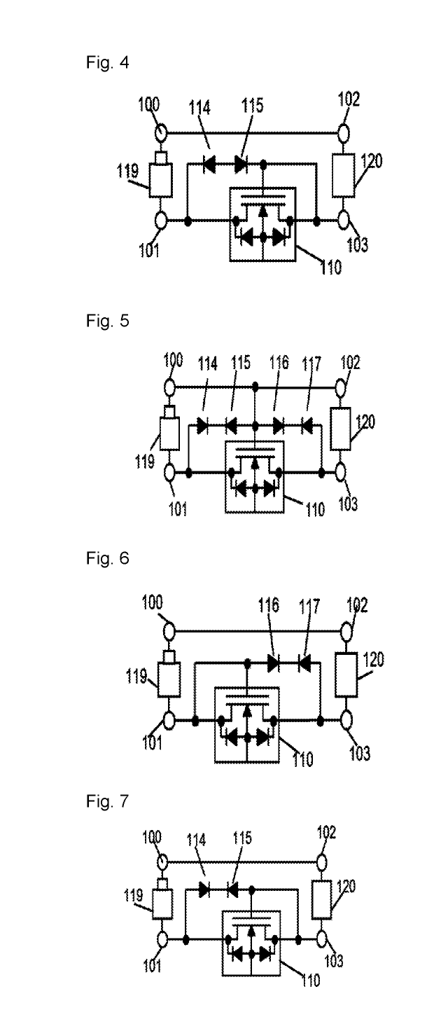

The controller 104 turns off the pass-on FET 105 and the pass-off FET 106 and 107 and turns on the pass-off FET 108 and 109. The equivalent circuit in this case is shown in FIGS. 4 and 7. The discharge direction becomes a normal direction where the current pass FET 110 is in the MOS-diode type, so the discharging becomes available, and the charging is prohibited since the charging direction becomes a reverse direction.

As a way to resolve a leakage current occurrence problem due to the pass-off FET (FIGS. 35—162 and 161) in the conventional technology, a pair of the pass-off FET 106 and 107 connected in series are provided between the gate node 123 of the current pass FET 110 and the battery node 101. The input into the level converter 111 is a low state, and the gate voltage at the pass-off FET 106 receives an output of the level converter 111, and this value is the same as the voltage at the node 103 and is the same as the electric potential at the gate node 123 of the current pass FET 110. In the charge-prohibited state, the charger 120 is connected, and the electric potential at the node 103 has a negative electric potential. In this state, since the gate voltage at the FET 106 has the electric potential same as the node 103, the leakage current via the FET 106 and 107 can be prevented.

### MODES FOR CARRYING OUT THE INVENTION

### Second Exemplary Embodiment

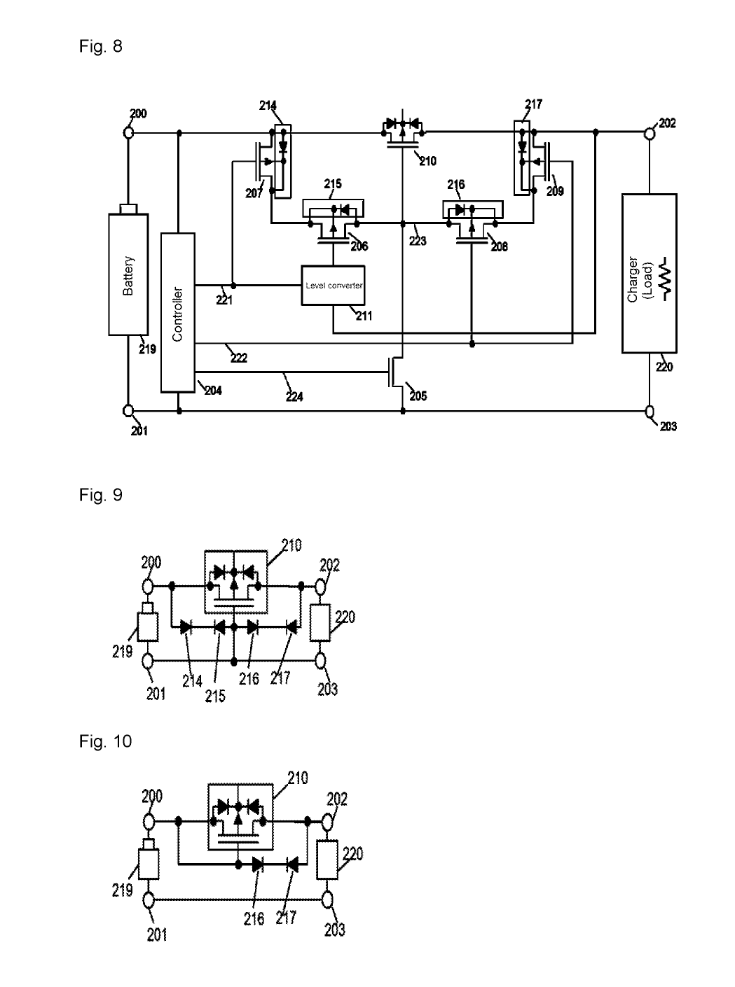

FIG. 8 is a view illustrating a battery charge and discharge control circuit including a controller 204 according to a second exemplary embodiment of the present invention.

The charge and discharge control circuit according to a second exemplary embodiment of the present invention may include, but is not limited to a controller 104; a current pass FET 210; a level converter 211; a pass-on FET 205; and a pass-off FET 206, 207, 208 and 209.

The source of the pass-on FET 205 is connected to the common terminals 201 and 203 of the battery 219 and the charger (load) 220. The gate of the FET 205 is connected to a controller signal 224. The drain of the FET 205 is connected to the gate of the current pass FET 210. One terminal 200 of the battery 219 is connected to the drain of the current pass FET 210, and the source of the current pass FET 210 is connected to the terminal 202 of the charger (load) 220. The pass-off FET 207 which receives the controller signal 221 as a gate input and the source of the FET 207 are connected to the node of the battery 200, and the drain of FET 207 is connected to the drain of the pass-off the FET 206, and the gate of the FET 206 is connected to the level converter 211, and the level converter 211 is connected to the control signal node 221. The source of the FET 206 is connected to the gate node 223 of the FET 210. The pass-off FET 209 which receives a second control signal 222 as a gate input and the source of the FET 209 are connected to the node of the charger (load) terminal 202, and the drain of the FET 209 is connected to the drain of the pass-off FET 208, and the gate of the FET 208 is connected to the control signal 222. The source of the FET 208 is connected to the gate node 223 of the FET 210.

The operation of the second exemplary embodiment of the present invention will be described below.

The normal state operation in FIG. 8 is as follows.

The current pass FET 210 should be in an on state. For this, the pass-on FET 205 is turned on, and the pass-off FET 206, 207, 208 and 209 are turned off. In this state, the current pass FET 210 becomes a full on state, thus passing the current in both directions. The electric equivalent circuit in this state is shown in FIGS. 9 and 12. The pass-on FET 205 may be connected in multiple series so as to receive multiple control signals. At the positions of the bulk nodes of the pass-off FET 206 and 207, each parasitic diode should be formed in a reverse direction, and at the positions of the bulk nodes of the pass-off FET 208 and 209, each parasitic diode should be formed in a reverse direction. In this configuration, the leakage current does not occur. In the normal state, the current pass FET 210 is in a full on state, and there is rarely a difference between the electric potential at the battery node 200 and the electric potential at the charger node 202. As long as only the positions of the parasitic diodes of the pass-off FET 206, 207, 208 and 209 are determined as mentioned earlier, a leakage current does not occur.

The operation of the discharge-prohibited (charge is available) in FIG. 8 will be described below.

The controller 204 turns off the pass-on FET 205 and the pass-off FET 208 and 209 and turns on the pass-off FET 206 and 207. The equivalent circuit in this case is shown in FIGS. 10 and 13. The charging direction becomes a normal direction where the current pass FET 210 is in the MOS-diode type, so the charging becomes available, and the discharging direction becomes a reverse direction, so the discharging is prohibited.

A pair of the pass-off FET 208 and 209 connected in series are connected between the gate node 223 of the current pass FET 210 and the load node 202. The gate node 222 of the FET 209 is in a high state, and the electric potential at the gate node 222 is the same as at the node 200 and is the same as the electric potential at the gate node 223 of the current pass FET 210. In the discharge-prohibited state, the load 220 is in a connected state, and the electric potential at the node 202 may drop to the electric potential at the maximum node 200. In the above state, the gate voltage at the FET 209 becomes an electric potential at the node 200, the leakage current can be prevented irrespective of the state of the pass-off FET 208.

The operation of the charge prohibition (discharge is available) in FIG. 8 will be described below.

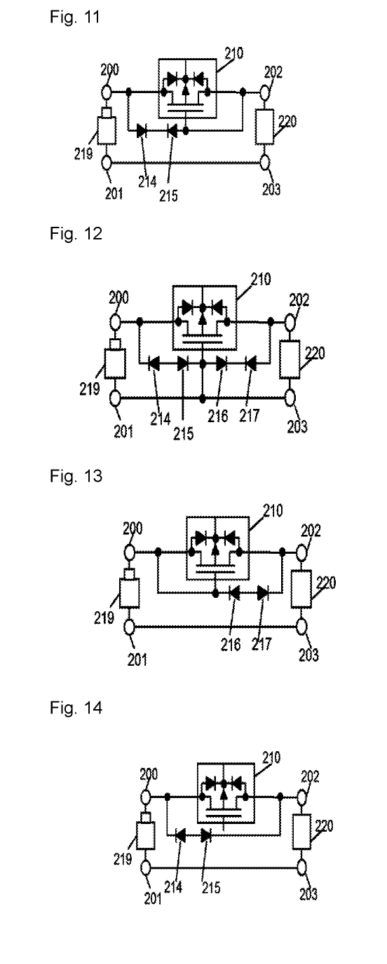

The controller 204 turns off the pass-on FET 205 and the pass-off FET 206 and 207 and turns on the pass-off FET 208 and 209. The equivalent circuit in this state is shown in FIGS. 11 and 14. The discharging direction becomes a normal direction where the current pass FET 210 is in the MOS-diode type, so the discharging becomes available, and the charging direction becomes a reverse direction, so the charging is prohibited.

A pair of the pass-off FET 206 and 207 connected in series are connected between the gate node 223 of the current pass FET 210 and the battery node 200. The input of the level converter 211 is in a high state, and the gate voltage at the pass-off FET 206 receives an output of the level converter 211, and this valve is the same as the voltage at the node 202 and is the same as the electric potential at the gate node 223 of the current pass FET 210. In the charge-prohibited state, the charger 220 is in a connected state, and the electric potential at the node 202 has a higher value than the electric potential at the battery node 200. In this state, since the gate voltage at the FET 206 has the same electric potential as the charger node 202, the leakage currents via the FET 206 and 207 can be prevented.

### Third Exemplary Embodiment

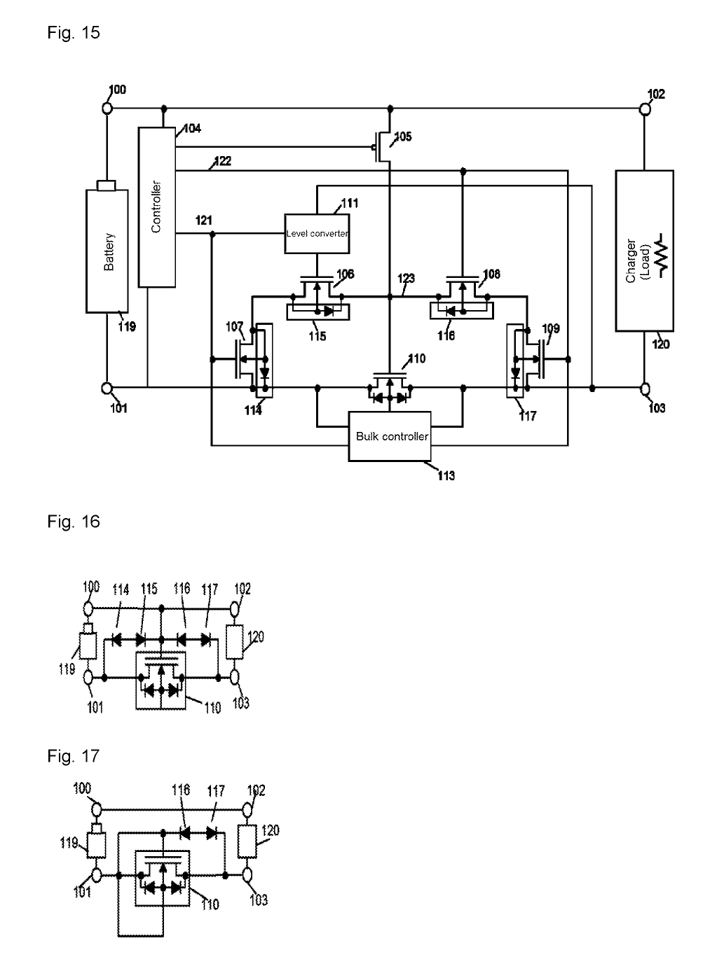

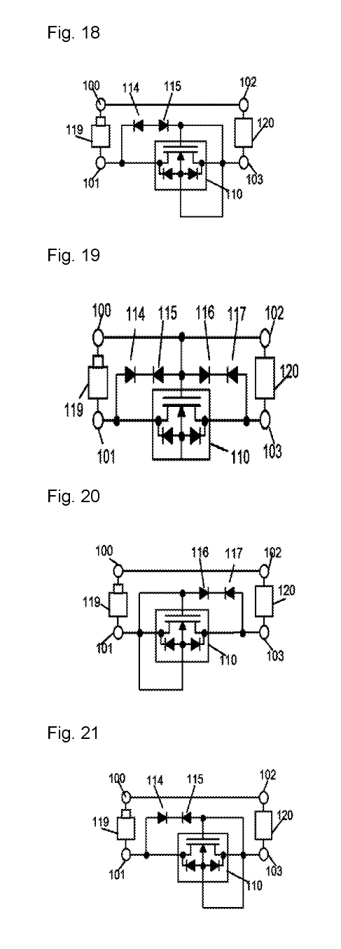

FIG. 15 is a view illustrating a battery charge and discharge control circuit including a controller 104 according to a third exemplary embodiment of the present invention.

The charge and discharge control circuit according to a third exemplary embodiment of the present invention may include, but is not limited to, a controller 104; a current pass FET 110; a level converter 11; a pass-on FET 105; pass-off FET 106, 107, 108 and 109; and a bulk controller 113.

The source of the pass-on FET 105 is connected to the common terminals 100 and 102 of the battery 119 and the charger (load) 120, and the gate of the FET 105 is connected to the controller signal 124. The drain of the FET 105 is electrically connected to the gate of the current pass FET 110. One terminal 101 of the battery 119 is connected to the drain (source) of the current pass FET 110, and the other source (drain) of the current pass FET 110 is connected to the terminal 103 of the charger (load) 120. The pass-off FET 107 which receives the controller signal 121 as a gate input and the source of the FET 107 are connected to the node of the battery terminal 101, and the drain of the FET 107 is connected to the drain of the pass-off FET 106, and the gate of the FET 106 is connected to the level converter 111, and the level converter 111 is connected to the control signal node 121. The source of the FET 106 is connected to the gate node 123 of the FET 110. The pass-off FET 109 which receives the controller signal 122 as a gate input and the source of the FET 109 are connected to the node of the charger (load) terminal 103, and the drain of the FET 109 is connected to the drain of the pass-off FET 108, and the gate of the FET 108 is connected to the control signal 122. The source of the FET 108 is connected to the gate node 123 of the FET 110. The bulk controller 113 is connected to the control signals 121 and 122 and to the battery node 101 and the charger node 103 and to the bulk node of the current pass FET 110.

The operation according to a third exemplary embodiment of the present invention will be described below.

The normal state operation in FIG. 15 is as follows.

The current pass FET 110 should be in an on state. For this, the pass-on FET 105 is turned on, and the pass-off FET 106, 107, 108 and 109 are turned off. In this state, the current pass FET 110 becomes a full on state, so the current can pass in both directions. The pass-on FET 105 may be connected in multiple series so as to receive multiple control signals. The bulk controller 113 may control the bulk node of the current pass FET 110 to move to the open position or the node 101 or the node 103. In the present embodiment, it is at the open position. The electrical equivalent circuit in this state is shown in FIGS. 16 and 19. At the positions of the bulk nodes of the pass-off FET 106 and 107, each parasitic diode should be formed in a reverse direction, and at the positions of the bulk nodes of the pass-off FET 108 and 109, each parasitic diode should be in a reverse direction. In this state, the leakage current does not occur. In the normal state the current pass FET 110 becomes a full on state. In this state, there rarely is a difference between the electric potential at the battery node 101 and the electric potential at the charger node 103. So, as long as only the positions of the parasitic diodes of the pass-off FET 106, 107, 108 and 109 are determined as mentioned above, a leakage current will not occur.

The operation of the discharge-prohibited (charge is available) in FIG. 15 will be described below.

The controller 104 turns off the pass-on FET 105 and the pass-off FET 108 and 109 and turns on the pass-off FET 106 and 107. The bulk controller 113 controls the bulk node of the current pass FET 110 to move to the node 101. The equivalent circuit in this case is shown in FIGS. 17 and 20. The charging direction becomes a normal direction wherein the current pass FET 110 is in the MOS-diode type, and the charging becomes available, so the discharging direction becomes a reverse direction, and the discharging is prohibited.

A pair of pass-off FET 108 and 109 connected in series are provided between the gate node 123 of the current pass FET 110 and the load node 103. The gate node 122 of the FET 109 is in a low state and its electric potential is the same as at the node 101 and is the same as the electric potential at the gate node 123 of the current pass FET 110. In the discharge-prohibited state, the load 120 is in a connected state, and the electric potential at the node 103 may rise to the electric potential of the maximum node 100. In the above state, since the gate of the FET 109 is in a 0V state, the leakage current can be prevented irrespective of the state of the pass-off FET 108.

The operation of the charge prohibition (charge is available) in FIG. 15 will be described.

The controller 104 turns off the pass-on FET 105 and the pass-off FET 106 and 107 and turns on the pass-off FET 108 and 109. The bulk controller 113 controls the bulk node of the current pass FET 110 to move to the node 103. The equivalent circuit in this case is shown in FIGS. 4 and 7. The discharging direction becomes a normal direction wherein the current pass FET 110 is in the MOS-diode, so the discharging becomes available, and the charging direction becomes a reverse direction, and the charging is prohibited.

A pair of the pass-off FET 106 and 107 connected in series are provided between the gate node 123 of the current pass FET 110 and the battery node 101. The input of the level converter 111 is in a low state, and the gate voltage at the pass-off FET 106 receives an output of the level converter 111 and is the same as the voltage at the node 103 and is the same as the electric potential at the gate node 123 of the current pass FET 110. In the charge-prohibited state, the charger 120 is in a connected state, and the electric potential at the node 103 has a negative electric potential. In this state, since the gate voltage at the FET 106 is the same as the electric potential at the node 103, the leakage current via the FET 106 and 107 can be prevented.

### Fourth Exemplary embodiment

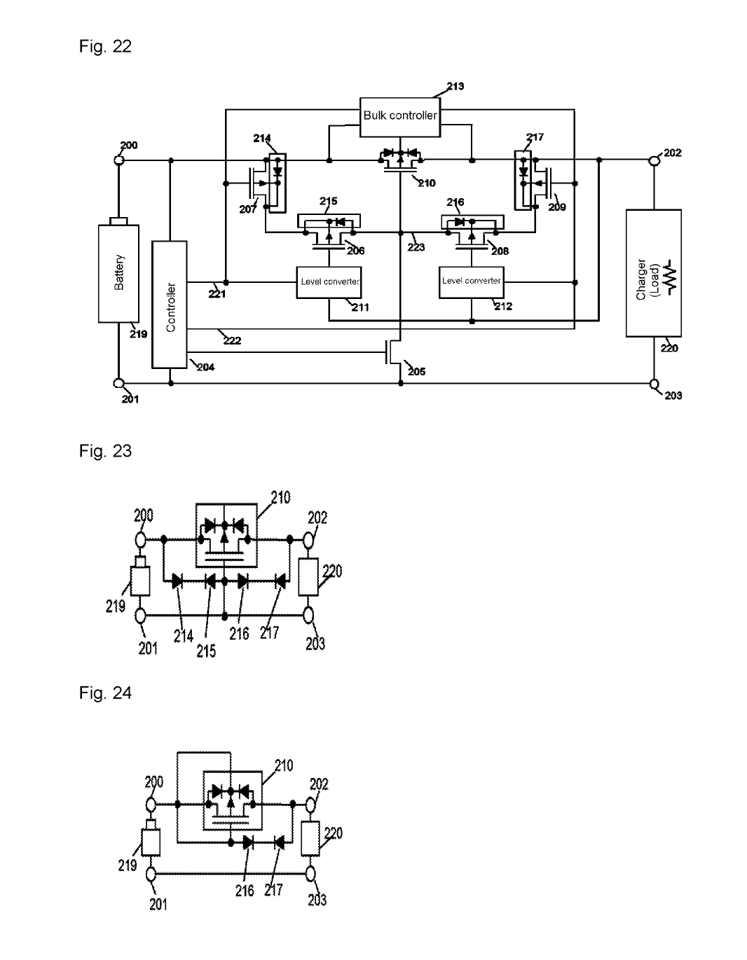

FIG. 22 is a view illustrating a battery charge and discharge control circuit including a controller 204 according to a fourth exemplary embodiment of the present invention.

The charge and discharge control circuit according to a fourth exemplary embodiment of the present invention may include, but is not limited to, a controller 204; a current pass FET 210; a level converter 211; a pass-on FET 205; pass-off FET 206, 207, 208 and 209 and a bulk controller 213.

The source of the pass-on FET 205 is connected to the common terminal 201 and 203 of the battery 219 and the charger (load) 220, and the gate of the FET 205 is connected to the controller signal 224. The drain of the FET 205 is connected to the gate of the current pass FET 210. One terminal 200 of the battery 219 is connected to the drain of the current pass FET 210, and the source of the current pass FET 210 is connected to the terminal 202 of the charger (load) 220. The pass-off FET 207 which receives the controller signal 221 as a gate input and the source of the FET 207 are connected to the node of the battery terminal 200, and the drain of the FET 207 is connected to the drain of the pass-off FET 206, and the gate of the FET 206 is connected to the level converter 211, and the level converter 211 is connected to the control signal node 221. The source of the FET 206 is connected to the gate node 223 of the FET 210. The pass-off FET 209 which receives the controller signal 222 as a gate input and the source of the FET 209 are connected to the node of the charger (load) 202, and the drain of the FET 209 is connected to the drain of the pass-off FET 208, and the gate of the FET 208 is connected to the control signal 222. The source of the FET 208 is connected to the gate node 223 of the FET 210. The bulk controller 213 is connected to the control signals 221 and 222 and to the battery node 200 and the charger node 202 and to the bulk node of the current pass FET 110.

The operation according to a fourth exemplary embodiment of the present invention will be described.

The normal state operation in FIG. 22 will be described.

The current pass FET 210 should be in an on state. For this, when the pass-on FET 205 is turned on, and the pass-off FET 206, 207, 208 and 209 are turned off, the current pass FET 210 becomes a full on state, so the current can pass in both directions. The pass-on FET 205 may be connected in multiple series so as to receive multiple control signals. The bulk controller 213 may control the bulk node of the current pass FET 210 to move to the open position or the node 100 or the node 202. In the present embodiment, it is at the open position. The electric equivalent in this state is shown in FIGS. 23 and 26. At the positions of the bulk nodes of the pass-off FET 206 and 207, each parasitic diode is formed in a reverse direction, and at the positions of the bulk nodes of the pass-off FET 208 and 209, each parasitic diode is formed in a reverse direction, so the leakage current does not occur. In the normal state, the current pass FET 210 is in a full on state, and there rarely is a difference between the electric potential at the battery node 200 and the electric potential at the charger node 202. As long as only the positions of the parasitic diodes of the pass-off FET 206, 207, 208 and 209 are determined as mentioned earlier, the leakage current does not occur.

The discharge prohibition (charge is available) operation in FIG. 8 will be described below.

The controller 204 turns off the pass-on FET 205 and the pass-off FET 208 and 209 and turns on the pass-off FET 206 and 207. In addition, the bulk controller 213 controls the bulk node of the current pass FET 210 to move to the node 200. The equivalent circuit in this state is shown in FIGS. 10 and 13. The charging direction becomes a normal direction wherein the current pass FET 210 is in the MOS-diode type, so the charging becomes available, and the discharging direction becomes a reverse direction, and the discharging is prohibited.

A pair of pass-off FET 208 and 209 connected in series are provided between the gate node 223 of the current pass FET 210 and the load node 202. The gate node 222 of the FET 209 is in a high state, and the electric potential at the gate node is the same as at the node 200 and is the same as the electric potential at the gate node 223 of the current pass FET 210. In the discharge-prohibited state, the load 220 is in a connected state, and the electric potential at the node 202 may lower to the electric potential at the maximum node 200. The gate voltage at the FET 209 in the above state becomes the electric potential at the node 200, so the leakage current can be prevented irrespective of the state of the pass-off FET 208.

The charge-prohibited (discharge is available) in FIG. 8 will be described as follows.

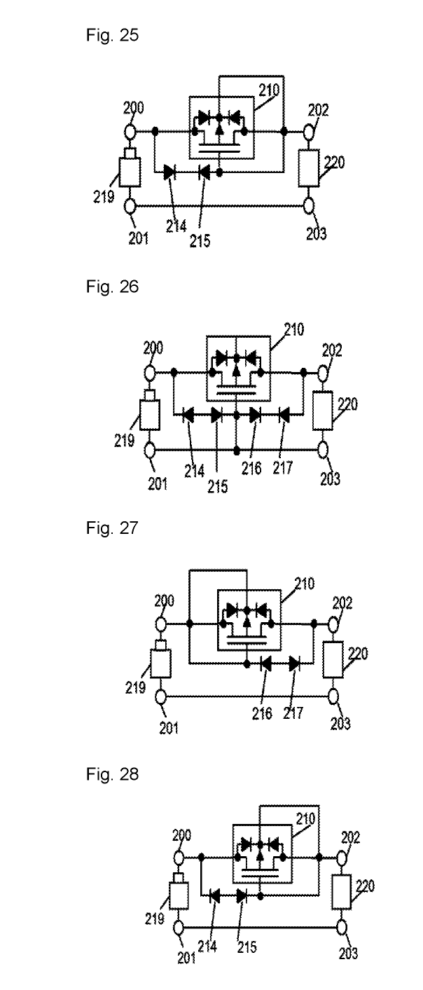

The controller 204 turns off the pass-on FET 205 and the pass-off FET 206 and 207 and turns on the pass-off FET 208 and 209. The bulk controller 213 controls the bulk node of the current pass FET 210 to move to the node 202. The equivalent circuit in this case is shown in FIGS. 25 and 28. The discharging direction becomes a normal direction wherein the current pass FET 210 is in the MOS-diode type, so the discharging becomes available, and the charging direction becomes a reverse, and the charging is prohibited.

A pair of pass-off FET 206 and 207 connected in series are provided between the gate node 223 of the current pass FET 210 and the battery node 200. The input of the level converter 211 is a high state, and the gate voltage at the pass-off FET 206 receives an output of the lever converter 211, and this value is the same as the voltage at the node 202 and is the same as the electric potential at the gate node 223 of the current pass FET 210. In the charge-prohibited state, the charger 220 is in a connected state, and the electric potential at the node 202 is higher than the electric potential at the battery node 200. In this state, since the gate voltage at the FET 206 has the same electric potential as the charger node 202, the current leakage via the FET 206 and 207 can be prevented.

### INDUSTRIAL APPLICABILITY

If the control is carried out using one current pass FET in the battery charge and discharge control circuit, the size of the current pass FET may be reduced ¼ as compared to when two FET are used in the conventional technology. If one current pass FET is used, the leakage current reduction may be the most important target. In the present invention, it is possible to completely control the leakage current.

1. A charging and discharging control circuit which operates in response to a charging and discharging control signal of a battery, comprising:
a charger (load) terminal node connected to a terminal of a battery;
a level converter;
a controller which generates a first control signal, a second control signal and a third control signal; and
a first FET, a second FET, a third FET, a fourth FET, a fifth FET and a sixth FET, wherein the source and drain of the first FET are connected between the terminal node and the gate of the sixth FET, and the gate of the first FET is connected to the first control signal, and the drain (source) of the sixth FET is connected to the other terminal of the battery, and the source (drain) of the sixth FET is connected to the other terminal of the charger (load), and the drain and source of the second FET and the drain and source of the third FET are connected between the gate and drain (source) of the sixth FET, and the drain and source of the fourth FET and the drain and source of the fifth FET are connected between the gate and drain (source) of the sixth FET, and the gate of the fourth FET receives the third control signal, and the gate of the fifth FET receives the third control signal, and the gate of the second FET receives the second control signal, and the gate of the third FET receives the second control signal, and the level converter is connected between one between the gate of the second FET and the gate of the third FET and the second control signal.
